(19) United States
(12) Patent Application Publication
(10) Pub. No.: US 2002/0165033 A1
(43) Pub. Date: Nov. 7, 2002

(54) Rotor shafts

(75) Inventors: Alex Horng, Kaohsiung (TW); Ching-Shen Hong, Kaohsiung (TW)

Correspondence Address: Bacon & Thomas, 4th Floor, 625 Slaters Lane, Alexandria, VA, 22314, US

(73) Assignee: Sunonwealth Electric Machine Industry Co., Ltd., Kaohsiung (TW)

(21) Appl. No.: 09/848,356

(22) Filed: May 4, 2001

(51) Int. Cl. F16C 3/00

(52) U.S. Cl. 464/179

(57) ABSTRACT

A rotor shaft comprises an end fixed to a base of a rotor. The rotor shaft further includes a distal end having a dome and an engaging groove. The engaging groove is annular and defined by a lower wall and an upper wall. At least one of the lower wall and the upper wall is connected with the outer periphery of the rotor shaft by an inclined section or a round. The inclined section is at an obtuse angle with the outer periphery of the rotor shaft.

### BACKGROUND OF THE INVENTION

1. Field of the Invention

The present invention relates to rotor shafts for preventing the bearings for the rotor shafts being scratched during assembly or detachment.

2. Description of the Related Art

FIG. 1 shows a conventional rotor shaft and FIG. 2 shows an axle tube for receiving the rotor shaft. As illustrated in FIG. 1, the rotor shaft 91 includes an engaging groove 92 in a distal end thereof for engaging with a washer 92 to thereby prevent disengagement of a bearing that rotatably receives the rotor shaft 91 and that is received in the axle tube 95. Thus, the rotor shaft 91 is rotatably mounted in the axle tube 94.

Nevertheless, the engaging groove 92 of the rotor shaft 91 includes a wall surface that is substantially perpendicular to an outer periphery of the rotor shaft 91. When mounting the rotor shaft 91, the bearing 94 is firstly engaged in the axle tube 95 and the rotor shaft 91 is extended through a longitudinal hole 96 of the bearing 94. Another method for mounting the rotor shaft 91 is firstly inserting the rotor shaft 91 through the longitudinal hole 96 of the bearing 94 and then fixing the bearing 94 inside the axle tube 95. In either case, the wall surface of the engaging groove 91 more or less scratches the inner periphery of the longitudinal hole 96 of the bearing 94. The problem is aggravated if it is required to pull the rotor shaft 91 out of the bearing 94 and re-insert it into the bearing 94 or if the bearing 94 is a copper bearing, oily bearing, or self-lubricating bearing that is made from softer material.

### SUMMARY OF THE INVENTION

It is the primary object of the present invention to provide a rotor shaft that will not damage the inner periphery of the longitudinal hole of the bearing during assembly.

A rotor shaft in accordance with the present invention comprises an end fixed to a base of a rotor. The rotor shaft further includes a distal end having a dome and an engaging groove. The engaging groove is annular and defined by a lower wall and an upper wall. At least one of the lower wall and the upper wall is connected with the outer periphery of the rotor shaft by an inclined section or a round. The inclined section is at an obtuse angle with the outer periphery of the rotor shaft.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is a perspective view of a conventional rotor shaft.

FIG. 2 is a schematic sectional view of the conventional rotor shaft and an axle tube for receiving the conventional rotor shaft.

FIG. 3 is a perspective view, partly cutaway, of a first embodiment of a rotor shaft in accordance with the present invention.

FIG. 4 is a partial sectional view of the rotor shaft in FIG. 3.

FIG. 5 is a partial sectional view of a second embodiment of the rotor shaft in accordance with the present invention.

FIG. 6 is a partial sectional view of a third embodiment of the rotor shaft in accordance with the present invention.

FIG. 7 is a partial sectional view of a fourth embodiment of the rotor shaft in accordance with the present invention.

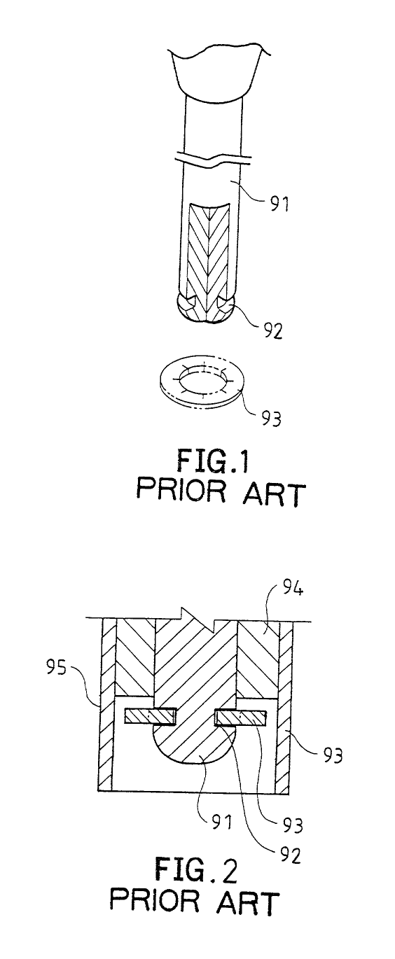

### DETAILED DESCRIPTION OF THE PREFERRED EMBODIMENTS

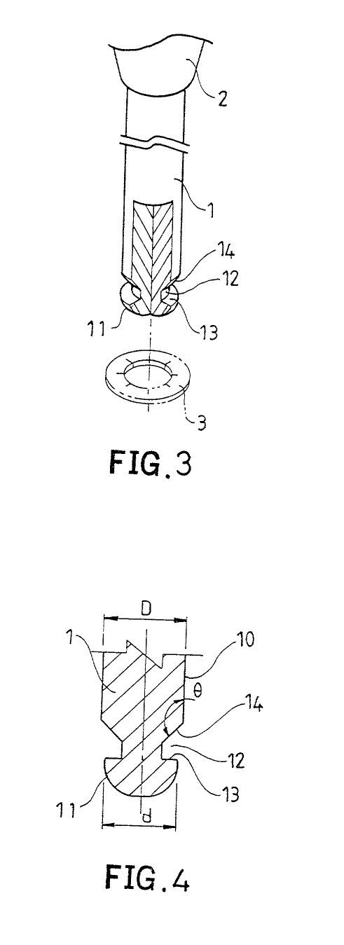

Referring to FIGS. 3 and 4, a first embodiment of a rotor shaft in accordance with the present invention generally includes an end fixed to a base 2 of a rotor (not shown). The other (distal) end of the rotor shaft 1 includes a dome 11. Defined in the rotor shaft I and adjacent to the distal end is an engaging groove 12. In this embodiment, the engaging groove 12 is an annular groove defined in an outer periphery of the rotor shaft 1.

The engaging groove 12 is defined by a lower wall 13 and an upper wall 14. The lower wall 13 is located on a plane that is substantially perpendicular to a longitudinal axis of the rotor shaft 1. When a fastener 3 (such as a C-clip or a washer) is engaged in the engaging groove 12, the fastener 3 abuts against the lower wall 13 to prevent disengagement of the fastener 3. In this embodiment, preferably, the lower wall 13 has an outer diameter “d” that is smaller than a diameter “D” of the rotor shaft 1.

As illustrated in FIG. 4, the upper wall 14 has an angle θ with an outer periphery of the rotor shaft 1. This angle θ is obtuse and is preferably 100°˜135°. Thus, either mounting a bearing via the distal end of the rotor shaft 1 (or removing the former from the later) or inserting the rotor shaft 1 into the bearing (or removing the rotor shaft 1 from the bearing), scratching damage to the inner periphery defining the longitudinal hole of the bearing is minimized.

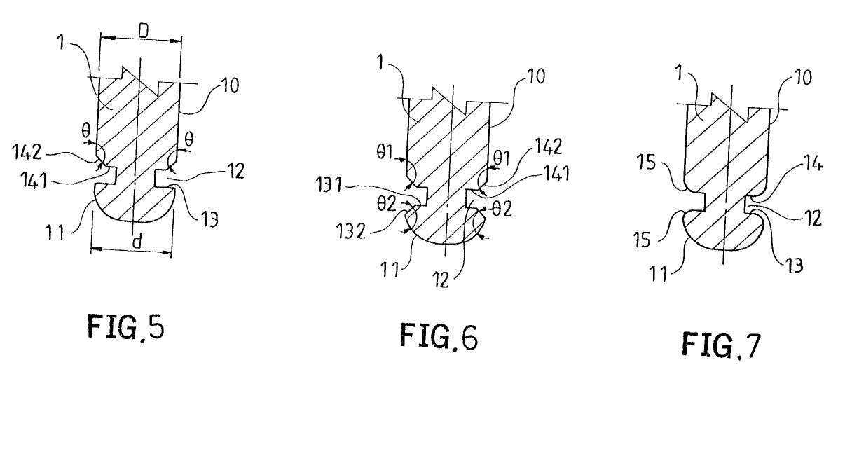

FIG. 5 illustrates a second embodiment of the rotor shaft 1, wherein the upper wall of the engaging groove 12 includes a horizontal section 141 that is substantially perpendicular to the longitudinal axis of the rotor shaft 1. The upper wall of the engaging groove 12 further includes an inclined section 142 that extends outward and upward from the horizontal section 141 and that has an obtuse angle θ with the outer periphery of the rotor shaft 1. The obtuse angle θ is preferably 100˜135°. Preferably, the distal end of the rotor shaft 1 includes a dome 11 and the lower wall 13 has an outer diameter “d” that is smaller than a diameter “D” of the rotor shaft 1.

FIG. 6 illustrates a third embodiment of the rotor shaft 1, wherein the lower wall of the engaging groove 12 includes a horizontal section 131 that is substantially perpendicular to the longitudinal axis of the rotor shaft 1. The lower wall of the engaging groove 12 further includes an inclined section 132 that extends outward and downward from the horizontal section 131 and that has an obtuse angle θ₂ with the outer periphery of the rotor shaft 1. The obtuse angle θ₂ is preferably 100°˜135°. In addition, the upper wall of the engaging groove 12 includes a horizontal section 141 that is substantially perpendicular to the longitudinal axis of the rotor shaft 1. The upper wall of the engaging groove 12 further includes an inclined section 142 that extends outward and upward from the horizontal section 141 and that has an obtuse angle θ₁ with the outer periphery of the rotor shaft 1. The obtuse angle θ₁ is preferably 100°˜135°. Preferably, the distal end of the rotor shaft 1 includes a dome 11 and the lower wall 13 has an outer diameter “d” that is smaller than a diameter “D” of the rotor shaft 1.

FIG. 7 illustrates a fourth embodiment of the rotor shaft 1, wherein the engaging groove 12 is defined by a lower wall 13 and an upper wall 14. Each of the lower wall 13 and the upper wall 14 is connected with the outer periphery of the rotor shaft 1 by a round 15. The distal end of the rotor shaft 1 includes a dome 11.

According to the above description, it is appreciated that the engaging groove 12 of the rotor shaft 1 includes a lower wall 13 having a horizontal section against which a fastener abuts, thereby preventing disengagement of the fastener that is received in the engaging groove 12. The upper wall 14 of the engaging groove 12 is either at an obtuse angle with the outer periphery of the rotor shaft 1 or connected with the outer periphery of the rotor shaft 1 by a round 15. The lower wall 13 of the engaging groove 12 is either at an obtuse angle with the outer periphery of the rotor shaft 1 or connected with the outer periphery of the rotor shaft 1 by a round 15. In addition, the outer diameter “d” of the lower wall 13 is smaller than the diameter “D” of the rotor shaft 1. As a result, either mounting a bearing via the distal end of the rotor shaft 1 (or removing the former from the later) or inserting the rotor shaft 1 into the bearing (or removing the rotor shaft 1 from the bearing), scratching damage to the inner periphery defining the longitudinal hole of the bearing is minimized. Longevity of the motor using the rotor shaft in accordance with the present invention is prolonged.

Although the invention has been explained in relation to its preferred embodiment as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. A rotor shaft comprising an end adapted to be fixed to a base of a rotor, the rotor shaft further including a distal end having a dome and an engaging groove, the engaging groove being annular and defined by a lower wall and an upper wall, the upper wall including an inclined section that is at an obtuse angle with an outer periphery of the rotor shaft.

2. The rotor shaft as claimed in claim 1, wherein the obtuse angle between the inclined section of the upper wall and the outer periphery of the rotor shaft is 100°˜135°.

3. The rotor shaft as claimed in claim 1, wherein the that is at an obtuse angle with the outer periphery of the rotor shaft.

4. The rotor shaft as claimed in claim 3, wherein the obtuse angle between the inclined section of the lower wall and the outer periphery of the rotor shaft is 100°˜135°.

5. The rotor shaft as claimed in claim 1, wherein the lower wall has an outer diameter smaller than a diameter of the rotor shaft.

6. The rotor shaft as claimed in claim 1, wherein the lower wall is connected with the outer periphery of the rotor shaft by a round.

7. A rotor shaft comprising an end adapted to be fixed to a base of a rotor, the rotor shaft further including a distal end having a dome and an engaging groove, the engaging groove being annular and defined by a lower wall and an upper wall, the upper wall being connected with an outer periphery of the rotor shaft by a round.

8. The rotor shaft as claimed in claim 7, wherein the lower wall includes an inclined section that is at an obtuse angle with the outer periphery of the rotor shaft.

9. The rotor shaft as claimed in claim 8, wherein the obtuse angle between the inclined section of the lower wall and the outer periphery of the rotor shaft is 100°˜135°.

10. The rotor shaft as claimed in claim 7, wherein the lower wall has an outer diameter smaller than a diameter of the rotor shaft.

11. The rotor shaft as claimed in claim 7, wherein the lower wall is connected with the outer periphery of the rotor shaft by a round.
